(19) United States
(12) Patent Application Publication
(10) Pub. No.: US 2007/0095029 A1
(43) Pub. Date: May 3, 2007

(54) Upright vacuum cleaner

(75) Inventors: Young Gun Min, Changwon-si (KR); Jae Kyum Kim, Gimhae-si (KR)

Correspondence Address: FISH & RICHARDSON P.C., P.O. BOX 1022, MINNEAPOLIS, MN, 55440-1022, US

(73) Assignee: LG Electronics Inc., Seoul (KR)

(21) Appl. No.: 11/260,685

(22) Filed: Oct. 28, 2005

(51) Int. Cl. B01D 45/12

(52) U.S. Cl. 55/345

(57) ABSTRACT

A vacuum cleaner includes a nozzle section, a cleaner body coupled to the nozzle section and being in fluid communication with the nozzle section, a dust collecting container operatively coupled with the cleaner body, a primary cyclone, a secondary cyclone, a discharge member arranged in the primary cyclone and a floatation prevention member. The primary cyclone and at least one secondary cyclone separate dust and dirt from a suction airflow flowing into the dust collecting container. The floatation prevention member is attached to an underside of the discharge member for preventing swirling airflow in the dust collecting container.

### BACKGROUND

This description relates to upright vacuum cleaners used for suctioning dirt and dust from carpets and floors.

Upright vacuum cleaners include a cleaner body having a handle, by which an operator of the vacuum cleaner may grasp and maneuver the cleaner, and a nozzle section which travels across a floor, carpet, or other surfaces being cleaned.

The cleaner body is often formed as a rigid plastic housing which encloses a dirt and dust collecting filter bag. The underside of the nozzle section includes a suction opening formed therein which is in fluid communication with the filter bag. A suction source such as a motor and fan assembly is enclosed within the cleaner body. The suction source generates the suction force required to pull dirt from the carpet or floor through the suction opening and into the filter bag.

Another type of upright vacuum cleaner utilizes cyclonic airflow to avoid the need for vacuum filter bags, and the associated expense and inconveniences of replacing filter bags. The cyclonic airflow is used instead of a filter bag to separate a majority of the dirt and other particulates from the suction airflow. The air is then filtered to remove residual particulates, returned to the motor, and exhausted.

However, conventional cyclonic airflow upright vacuum cleaners have not been found to be entirely effective and convenient to use. For example, with conventional cyclonic airflow vacuum cleaners, the process of emptying dust and dirt from dust collector may be inconvenient.

Also, in a conventional vacuum cleaner having the above-mentioned configuration, the dirt and dust stored in the dust collector rise because of the swirling forces being produced by the suction source.

Also, in the conventional vacuum cleaner having the above-mentioned configuration, the process of handling the cleaner body and the nozzle section is difficult when a user controls the cleaner body for operating the vacuum cleaner.

### SUMMARY

In one general aspect, a vacuum cleaner includes a nozzle section, a cleaner body coupled to the nozzle section and being in fluid communication with the nozzle section, and a dust collecting container operatively coupled with the cleaner body. The vacuum cleaner may include a primary cyclone for separating dust and dirt from a suction airflow flowing into the dust collecting container. The vacuum cleaner may include at least one secondary cyclone disposed along a periphery of the primary cyclone for separating dust and dirt entrained in the airflow discharged from the primary cyclone.

The vacuum cleaner may include a discharge member being centrally arranged in the primary cyclone for filtering the airflow prior to the airflow being discharged from the primary cyclone.

The vacuum cleaner also may include a floatation prevention member attached to an underside of the discharge member for preventing swirling airflow in the dust collecting container. The floatation prevention member may include an inclined portion and at least one cross blade attached to an underside of the inclined portion.

The discharge member may include holes formed along a periphery of the discharge member. The discharge member may be mounted on the upper end of the primary cyclone. An inner diameter of the discharge member may reduce gradually along a central axis of the discharge member.

The vacuum cleaner may include a main filter assembly located on an upper part of the at least one secondary cyclone for filtering dust and dirt from the airflow discharged from the at least one secondary cyclone.

The suction source may include a suction source inlet adjacent to a secondary airflow outlet of the at least one secondary cyclone.

A periphery of the at least one secondary cyclone may be partially defined by the dust collecting container.

A primary airflow inlet of the primary cyclone may be tangentially oriented in relation to an axial centerline of the primary cyclone and a primary airflow outlet of the primary cyclone is located in a center of an upper surface of the primary cyclone.

A secondary airflow inlet of the at least one secondary cyclone may be located in an upper periphery of the at least one secondary cyclone and the secondary airflow outlet of the at least one secondary cyclone may be located along a longitudinal axis of the at least one secondary cyclone.

The dust collecting container may include a primary dust storing part for storing dust and dirt separated in the primary cyclone. The dust collecting container may include a secondary dust storing part for storing dust and dirt separated in the at least one secondary cyclone.

In another general aspect, a vacuum cleaner includes a nozzle section, a cleaner body coupled to the nozzle section and in fluid communication with the nozzle section, and a dust collecting container operatively coupled with the cleaner body. The vacuum cleaner may include a primary cyclone for separating dust and dirt from a suction airflow flowing into the dust collecting container.

The vacuum cleaner may include at least one secondary cyclone for separating dust and dirt entrained in the airflow discharged from the primary cyclone.

The vacuum cleaner may include a main filter assembly located on an upper part of the at least one secondary cyclone for filtering dust and dirt from the airflow discharged from the at least one secondary cyclone. The main filter assembly may include a main filter element and a filter supporter for supporting and installing the main filter element. An auxiliary filter assembly may be disposed downstream from the main filter assembly.

The vacuum cleaner may include a bottom panel coupled to the dust collecting container for covering the dust collecting container. The primary cyclone may be located in the dust collecting container and a periphery of the at least one secondary cyclone may be at least partially defined by the dust collecting container.

In another general aspect, an upright vacuum cleaner includes a nozzle section, an upright cleaner body pivotally mounted to the nozzle section and in fluid communication with the nozzle section, and a rotation shaft provided at the upright cleaner body for pivotally mounting the upright cleaner body to the nozzle section. The vacuum cleaner may include a body release lever for selectively controlling an inclined operative position of the upright vacuum cleaner. The vacuum cleaner may include an agitator motor mounted in the nozzle section for driving an agitator of the vacuum cleaner. The vacuum cleaner may include a suction source mounted in the upright cleaner body for generating a suction force in the upright cleaner body.

The vacuum cleaner may include a dust collecting container selectively mounted in at least one of the upright cleaner body and the nozzle section.

The vacuum cleaner may include a primary cyclone for separating dust and dirt from a suction airflow flowing into the dust collecting container. The vacuum cleaner also may include at least one secondary cyclone for separating dust and dirt entrained in the airflow discharged from the primqary cyclone. The at least one secondary cyclone may be disposed along a periphery of the primary cyclone. The at least one secondary cyclone and the primary cyclone may be formed as a single piece.

The main filter assembly may be located on an upper part of the at least one secondary cyclone for filtering dust and dirt from the airflow discharged from the at least one secondary cyclone.

The primary airflow inlet of the primary cyclone may be tangentially oriented in relation to an axial centerline of the primary cyclone.

The dust collecting container may include a primary dust storing part for storing dust and dirt separated in the primary cyclone. The dust collecting container may include a secondary dust storing part for storing dust and dirt separated in the at least one secondary cyclone.

The vacuum cleaner may include a top cover detachably connected to the dust collecting container and positioned at an upper end of the dust collecting container.

The vacuum cleaner may include a conduit extending from the at least one secondary cyclone to the suction source.

The vacuum cleaner may include a primary airflow outlet of the primary cyclone located in a center of an upper surface of the primary cyclone.

The at least one secondary cyclone may include a plurality of secondary cyclones disposed along a periphery of the primary cyclone. The vacuum cleaner may include secondary airflow inlets for each of the secondary cyclones, the secondary airflow inlets being positioned above a position of the primary airflow outlet of the primary cyclone.

The vacuum cleaner may provide a simple coupling structure, may be convenient to use, and may prevent dust and dirt from rising out of dust collection container due to the spiral airflow.

Other features and advantages will be apparent from the following description, including the drawings, and the claims.

### BRIEF DESCRIPTION OF THE DRAWINGS

FIG. 1 is a perspective view of a cyclonic airflow upright vacuum cleaner.

FIG. 2 is a partial, perspective view of an operative mode of the upright vacuum cleaner of FIG. 1.

FIG. 3 is a side view of the vacuum cleaner of FIG. 1.

FIG. 4 is a rear view of the vacuum cleaner of FIG. 1.

FIG. 5 is a bottom, plan view of the vacuum cleaner of FIG. 1.

FIG. 6 is a partial, side sectional view of the vacuum cleaner of FIG. 1.

FIG. 7 is an exploded, perspective view of the dust collector shown in FIG. 1.

FIG. 8 is a perspective view illustrating an upper part of the dust collector shown in FIG. 7.

FIG. 9 is a partial, side sectional view of the dust collector shown in FIG. 7.

### DETAILED DESCRIPTION

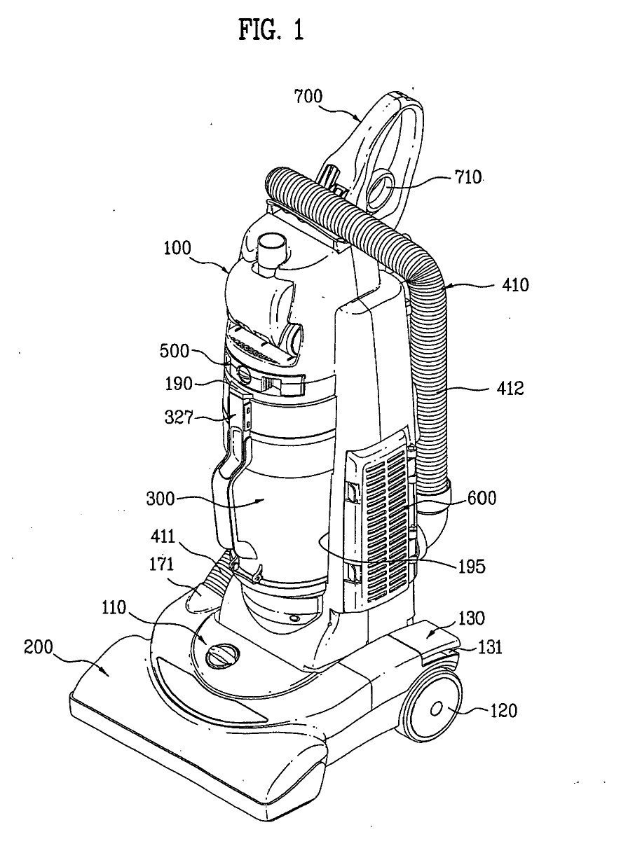

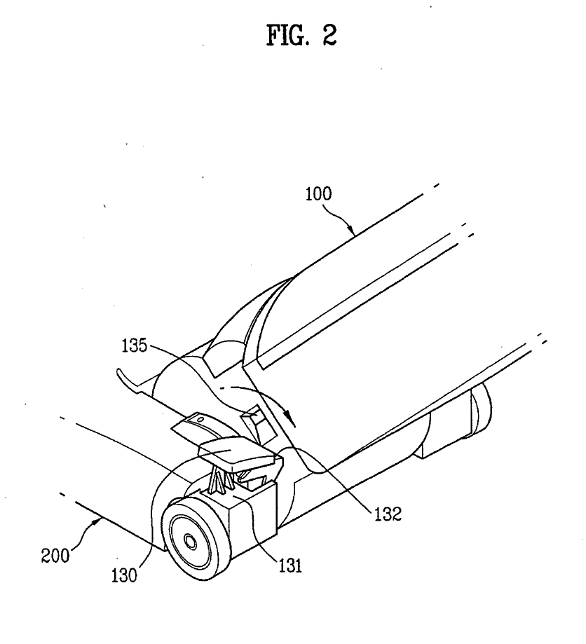

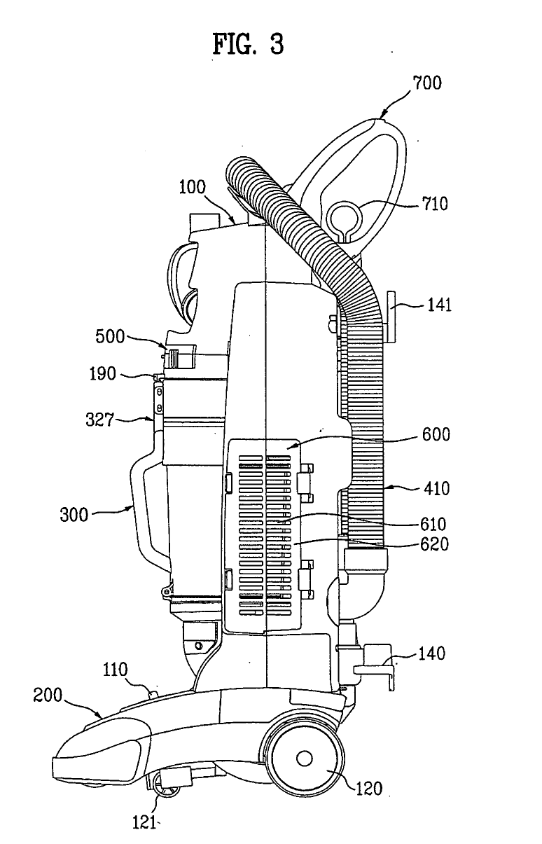

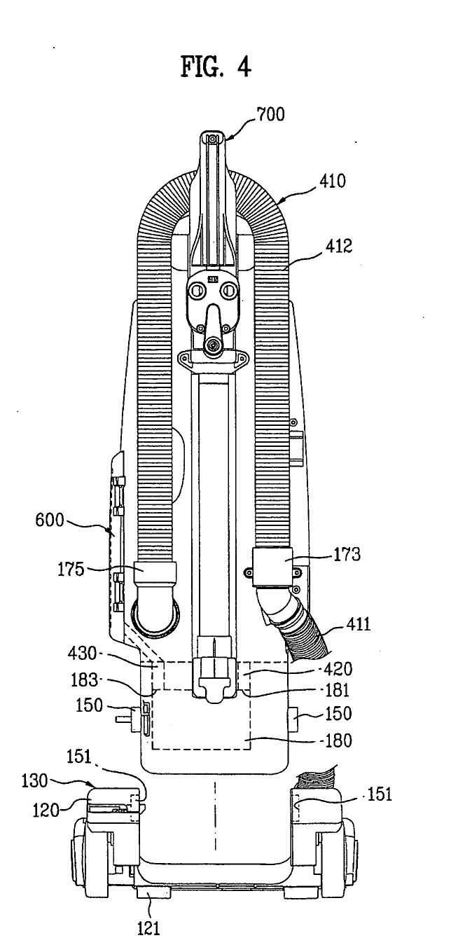

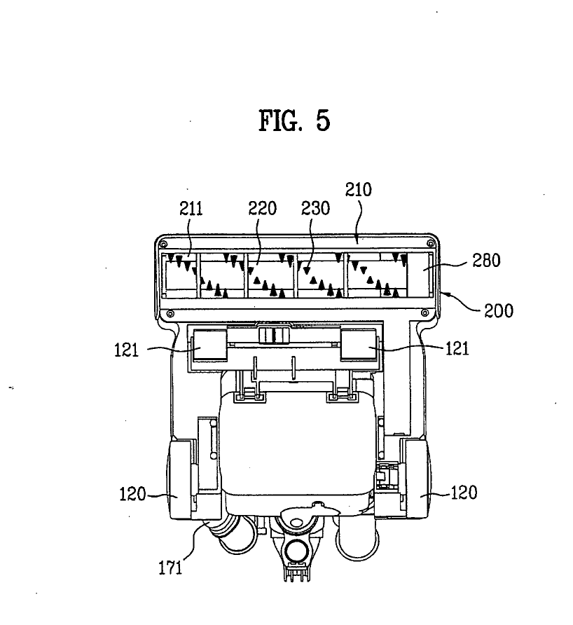

Referring to FIGS. 1-6, an upright vacuum cleaner includes a cleaner body 100, a nozzle section 200 connected to the cleaner body 100, and conduits for guiding the suction airflow from the nozzle section 200 to the atmosphere while passing through the cleaner body 100.

The cleaner body 100 and the nozzle section 200 are connected through a pivot or hinge, such as a suitable hinge assembly, so that the cleaner body 100 pivots between a generally vertical storage position (as shown) and an inclined, operative position. The hinge assembly includes a rotation shaft 150 and rotating shaft holes 151 corresponding to the rotation shaft 150. The rotation shaft 150 protrudes from two lower opposing sides of the cleaner body 100 and the rotating shaft holes are provided at nozzle section 200 for retaining the rotation shaft 150.

The cleaner body 100 and nozzle section 200 are connected to each other as the rotation shaft 150 is inserted into the rotating shaft hole 151, allowing the cleaner body and the nozzle section to rotate freely with respect to each other.

The nozzle section 200 includes a nozzle case 210, a suction opening 211 which is formed at the underside of the nozzle case 210, and a rotating brush assembly which is provided in the nozzle case 210. Front wheels 121 and rear wheels 120 are rotatably mounted to underside of the nozzle case 210 to enable the nozzle section 200 to smoothly move on a floor.

The suction opening 211 extends substantially across the width of the nozzle case 210 at the front end thereof. The suction opening 211 is in fluid communication with the cleaner body 100 through a first conduit 410.

The rotating brush assembly includes an agitator 220, an agitator brush 230 which is provided at the outer circumference of the agitator 220, and an agitator motor 280 for driving the agitator 220.

The agitator 220 is positioned in the region of the suction opening 211 for contacting and scrubbing the surface being vacuumed to loosen embedded dirt and dust. The agitator 220 is axially connected to a shaft of the agitator motor 280 mounted in the nozzle case 210. When the rotational force of the agitator motor 280 is transferred to the agitator 220, the agitator rotates and brushes up contaminants from the surface being cleaned.

In addition to the agitator motor 280, a suction source 180 is mounted in the cleaner body for generating a suction force in the cleaner body 100. In this case, it is preferable that a is capacity of the agitator motor is smaller than that of the suction source.

A height adjustment knob 110 is rotatably mounted in the nozzle section 200. The user rotates the height adjustment knob 110 with his/her hand to raise or lower a shaft supporting front wheels (not shown) of the vacuum cleaner, and thus adjust the height of the nozzle section 200. In one implementation, the height adjustment knob 110 is capable of adjusting the height of the nozzle section incrementally and in accordance with the state of the surface to be cleaned.

The cleaner body 100 includes a control part (not shown) for controlling the vacuum cleaner, the suction source 180 for generating the required suction airflow for cleaning operations, and a dust collector 300 for separating contaminants entrained in the suction airflow passed through the suction opening 211. The cleaner body may also include a coupling device including a latch 327 and a coupling protrusion 190 for coupling the dust collector to the cleaner body. The cleaner body may further include a socket 195 for selectively holding the dust collector 300. The socket is formed as a recess having several grooves corresponding to the surface of the dust collector.

The suction source 180 includes an electronic motor and a fan generating a suction force in a suction source inlet 181 and an exhaust force in a suction source outlet 183.

The suction source outlet 183 is in fluid communication with a final filter assembly 600 for filtering the exhaust airflow of any contaminants immediately prior to its discharge into the atmosphere. The suction source inlet 181 is in fluid communication with the dust collector 300 of the cleaner body 100. Alternatively, the suction source may be disposed in the nozzle section 200.

The cleaner body 100 further includes a handle 700 extending upwardly therefrom by which a user of the vacuum cleaner is able to grasp and maneuver the vacuum cleaner. The handle 700 includes a telescopic release lever 710 for adjusting the height of the handle according to a height of the user.

The cleaner body 100 further includes a cord hook provided at rear side of the cleaner body 100. The cord hook includes an upper cord hook 141 and a lower cord hook 140 corresponding to the upper cord hook. The space between the upper cord hook 141 and the lower cord hook 140 is sufficient to accommodate the number of turns necessary to store the entire length of the cord. A cord holder (not shown) adjacent to the cord hook prevents the cord releasing from its stored position.

The conduits include a first conduit 410 connecting the suction opening 211 to dust collector 300, a second conduit 420 connecting the dust collector 300 to the suction source inlet 181, and a third conduit 430 connecting the suction source outlet 183 to the atmosphere.

The first conduit 410 includes hoses supported and connected by fitting members. One side of a first fitting member 171 is connected to a first hose 411 and the other side of the first fitting member 171 is connected to a passage 170 which is in fluid communication with the suction opening 211.

A second fitting member 173 connects the first hose 411 to a second hose 412 and a third fitting member 175 connects the second hose 412 to the cleaner body. Each of first and second hose (411, 412) is detachably connected to the second fitting member 173. The vacuum cleaner further includes a body release lever 130 for an inclined, operative position of the vacuum cleaner. The body release lever 130 is pivotably mounted on a mounting portion 131 which is provided at the nozzle section. The body release lever 130 has a locking protrusion 132 protruding from a side thereof. The locking protrusion 132 is sequentially locked in one or more locking recesses 135 provided at a lower side of cleaner body. When the vacuum cleaner is in use, a locking protrusion 132 is locked in one of the inclined position recesses 135 with the cleaner body 100 rotated at a predetermined angle with respect to a surface to be cleaned.

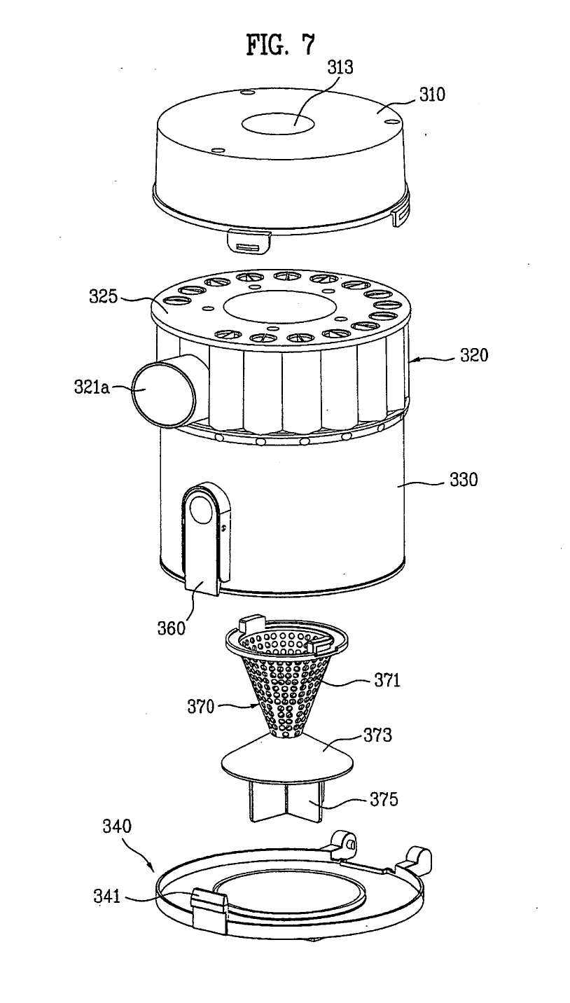

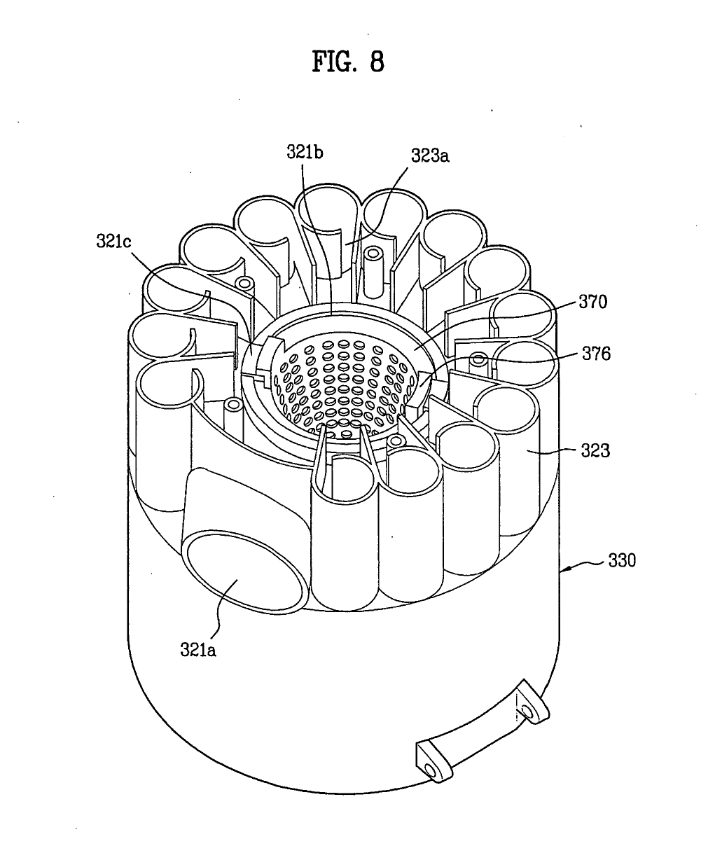

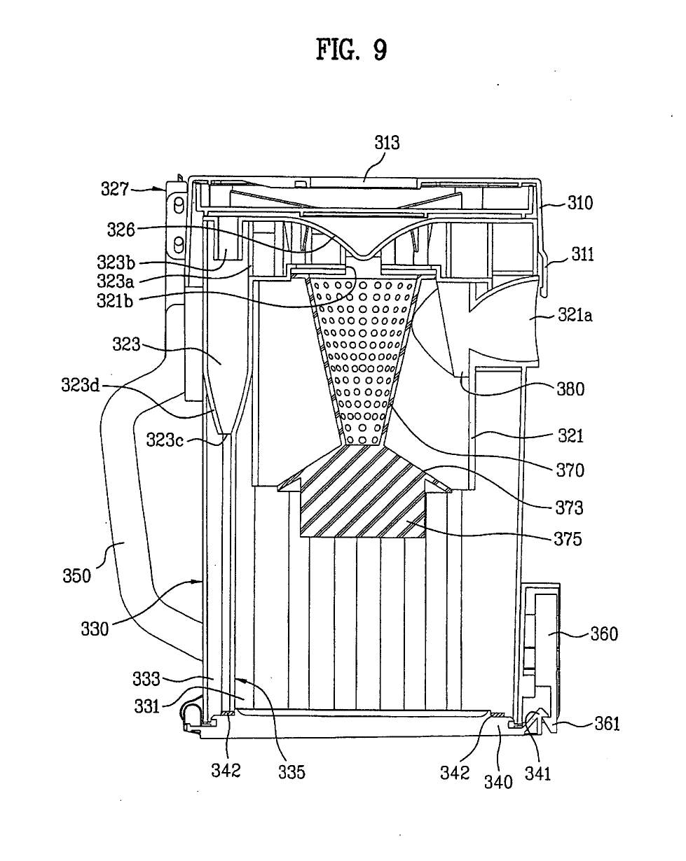

Referring to the FIGS. 7-9, the dust collector 300 includes a cyclonic chamber 320, a dust collecting container 330, a bottom panel 340 which is positioned at a lower end of the dust collecting container 330 and a top cover 310 which is positioned at an upper end of the cyclonic chamber 320.

The dust collecting container and the cyclonic chamber may be formed as a single piece.

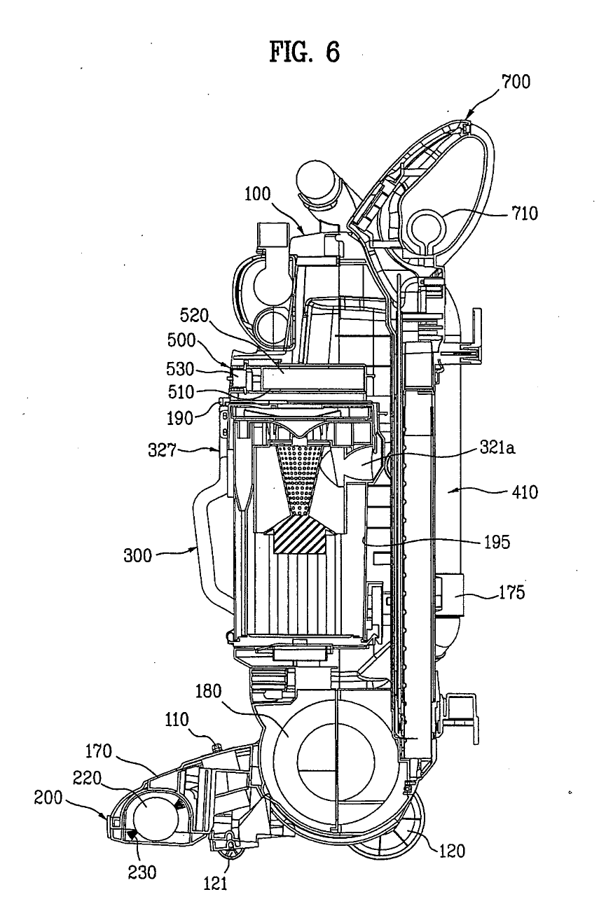

The dust collector 300 further includes a dust collector handle 350 which is provided on the exterior of the dust collecting container 330 for handling the container. The latch 327 is positioned at the upper end of the dust collector handle 350 for coupling the dust collector to the cleaner body, and the coupling protrusion 190 (as shown in FIG. 6) is formed at a front portion of the cleaner body.

The cyclonic chamber 320 includes a primary cyclone 321 and at least one secondary cyclone 323. The primary cyclone 321 separates dust and dirt from the suction airflow passed through the suction opening 211. The secondary cyclone 323 separates dust and dirt entrained in the airflow discharged from the primary cyclone 321.

The primary cyclone 321 has a downwardly-opened, cylindrical container shape. A primary airflow inlet 321a is formed through an upper portion of the primary cyclone 321 at one side of the primary cyclone 321. A primary airflow outlet 321b is formed through the top of the primary cyclone 321 so that the primary airflow outlet 321b extends vertically.

The primary airflow inlet 321a is tangentially oriented and arranged so that the airflow entering the primary cyclone 321 through the primary airflow inlet 321a moves in a spiral within the primary cyclone 321. That is, the primary airflow inlet 321a guides dirt-laden air into the cyclonic chamber 320 in a tangential direction of the primary cyclone 321 so that the air flows spirally along an inner wall surface of the primary cyclone 321.

The one or more secondary cyclones 323 have peripheral walls formed integrally with a peripheral wall of the cyclonic chamber 320. The secondary cyclones 323 are partitioned each from other by peripheral walls of the secondary cyclones 323. The cyclonic chamber 320 may be constructed as a single piece with the dust collecting container 330 and at least partially defining the dust collecting container 330.

In particular, the secondary cyclones 323 are circumferentially arranged around the primary cyclone 321. Each secondary cyclone 323 has an upper end upwardly protruding to a level higher than that of the upper end of the primary cyclone 321.

The peripheral wall of each secondary cyclone 323 is vertically cut out at a region where the peripheral wall is upwardly protruded above the upper end of the primary cyclone 321, thereby forming a secondary airflow inlet 323a communicating with the primary airflow outlet 321b.

Each secondary cyclone 323 may also be formed with a partial conical shape. The secondary cyclone 323 has a conical portion 323d formed at a lower portion of the secondary cyclone 323 such that the conical portion 323d has a diameter gradually reduced as the conical portion extends toward the bottom of the dust collecting container 330.

A contaminants discharge port 323c is formed at a lower end of each secondary cyclone 323 to downwardly discharge contaminants such as dust.

The secondary cyclones 323 have an integrated structure such that adjacent secondary cyclones of the secondary cyclones 323 are in contact with each other to prevent air from leaking between the adjacent secondary cyclones 323.

The cyclonic chamber 320 may further include a chamber cover 325 mounted to the upper end of the cyclonic chamber 320 to open or close the upper ends of the secondary cyclones 323.

A flow passage guide 326 is provided at the underside of the chamber cover 325. The flow passage guide 326 guides air emerging from the primary airflow outlet 321b more smoothly to the secondary cyclones 323.

The secondary airflow inlet 323a of each secondary cyclone 323 guides air discharged from the primary airflow outlet 321b to flow in a tangential direction of the secondary cyclone 323, so that the air entering the secondary airflow inlet 323a flows spirally along an inner wall surface of the secondary cyclone 323. Secondary airflow outlets 323b are formed at the chamber cover 325 along the peripheral portion of the chamber cover 325 to discharge air from the secondary cyclones 323.

Dust separated in the primary cyclone 321 and secondary cyclones 323 is stored in a dust storing part formed by the dust collecting container 330 and the bottom panel 340. The stored dust is subsequently outwardly discharged by virtue of gravity when the bottom panel 340 is opened.

An opening/closing device 360 is mounted to the peripheral wall of the dust collecting container 330 to open or close the bottom panel 340. The opening/closing device 360 includes a locking hook 361 for locking the bottom panel 340. The bottom panel 340 may include a bottom hook 341 corresponding to the locking hook 361.

The dust collecting container 330 may be at least partially transparent so that an operator of the vacuum cleaner is able to view the level of dirt and dust accumulated therein for purposes of determining when the dust collecting container should be emptied.

The dust storing part may include a primary dust storing part 331 for storing the dust separated by the primary cyclone 321, and a secondary dust storing part 333 for storing dust separated by the secondary cyclones 323.

The primary dust storing part 331 and secondary dust storing part 333 are partitioned by a substantially cylindrical boundary wall 335, which is connected to the secondary cyclones 323, and has a diameter smaller than that of the peripheral wall of the dust collecting container 330.

The boundary wall 335 has a lower end extending downward to the bottom of the dust collecting container 330, such as the upper surface of the bottom panel 340, beyond the lower end of the primary cyclone 321.

The boundary wall 335 may have a circumferentially corrugated shape, in order to prevent the dust stored in the primary dust storing part 331 from floating upwardly due to a spiral air flow formed in the primary cyclone 321.

A sealing member 342 is mounted between the boundary wall 335 and the bottom panel 340. The sealing member 342 having a cylindrical shape may be made from an elastic material. Accordingly, the sealing member 342 prevents the primary dust storing part 331 from communicating with the secondary dust storing parts 333.

Other implementations may include a dust collector 300 including a discharge member 370 mounted on the upper end of the primary cyclone 321. A plurality of holes 371 are formed at a peripheral wall of the discharge member 370 in order to allow the discharge member 370 to communicate with the primary airflow outlet 321b of the primary cyclone 321.

The discharge member 370 may be centrally arranged in the primary cyclone 321, may extend axially through the primary cyclone 321, and may have a substantially conical structure having an opened upper end and a closed lower end while having a diameter gradually reducing as the discharge member 370 extends downward.

When the discharge member 370 has such a structure, the velocity of the spiral air flow in the primary cyclone 321 is gradually reduced toward the lower end of the primary cyclone 321. Therefore, it is possible to prevent dust from being influenced by a suction force exerted in the discharge member 370. Alternatively, the discharge member 370 may have a cylindrical shape.

The upper end of the discharge member 370 is separably coupled to the peripheral edge of the primary airflow outlet 321b. For example, a coupling part 376 is coupled to a coupling protrusion 321c formed at the upper edge of the primary airflow outlet 321b. An annular sealing member (not shown), which provides a sealing effect, is interposed between the upper end of the discharge member 370 and the primary airflow outlet 321b.

A floatation prevention member 373 may also be mounted to the lower end of the discharge member 370 in order to prevent the dust collected in the primary dust storing part 331 from rising due to the spiral air flow and entering the secondary cyclones 323.

For example, the floatation prevention member 373 may have an inclined portion formed integrally with the lower end of the discharge member 370. The inclined portion may also have a radially-extending and downwardly-inclined, upper surface. Specifically, the floatation prevention member 373 may have a conical structure having a diameter gradually increasing as the floatation prevention member 373 extends downward.

A cross blade 375 may be attached under the inclined portion for preventing swirling airflow and air turbulence in the primary dust storing part 331 causing dust to rise up. However, the structure of the floatation prevention member 373 may be modified for specific airflows.

The dust collector 300 may include a guide rib 380 provided at the primary cyclone 321. The guide rib 380 guides air entering the primary airflow inlet 321a to flow in a direction tangential to the inner peripheral wall surface of the primary cyclone 321. The guide rib 380 prevents the air entering the primary airflow inlet 321a from being directly introduced into the discharge member 370.

A main filter assembly 500 may be located on the dust collector 300 for filtering contaminants from the airflow discharged from the secondary cyclone 323.

The main filter assembly 500 includes a filter housing 510 and a main filter element 520 mounted in the filter housing 510, and a filter housing knob 530 for handling the filter housing. The filter housing 510 is detachably coupled to the cleaner body and receives and retains the main filter element 520. The filter housing 510 includes a plurality of apertures, slots, or other passages formed therethrough, such as in the lower half thereof, so that the suction airflow flows freely from the cover discharge port 313, into the filter housing 510 and to the main filter element 520.

The main filter element 520 may be made of permeable material. For cleaning the main filter element 520, the user is able to detach the filter housing 510 from the cleaner body by rotating and drawing out the filter housing knob 530.

The main filter element 520 may include Porex R™ brand high density polyethylene-based, open-celled porous media available commercially from Porex Technologies Corp., Fairburn, Ga. 30213, or an equivalent foraminous filter member. The main filter element 520 is a rigid open-celled foam that is moldable, machinable, and otherwise workable into any shape as deemed advantageous for a particular application. The preferred filter element has an average pore size in the range of 45 μm to 90 μm to optimize filtration, but also to allow sufficient airflow rates.

The main filter assembly 500 may further include a filter supporter (not shown) for supporting and fixing the main filter element 520. The filter supporter may be formed at the inner frame of the filter housing. The main filter assembly 500 may be positioned in the top cover 310.

The cleaner body 100 also includes a final filter assembly 600 for filtering the suction airflow immediately prior to its exhaustion into the atmosphere. The preferred final filter assembly 600 includes a final filter element 610 and a final filter housing 620 for retaining the final filter element.

The final filter element 610 may be a high efficiency particulate arrest (HEPA) filter element in a sheet or block form. The final filter housing 620 has protective grid or grate structure for securing the final filter element 610 in place.

The vacuum cleaner may further include an auxiliary filter assembly (not shown) disposed downstream from the main filter assembly. The auxiliary filter assembly includes an auxiliary filter element (not shown), a filter supporter for supporting and installing the auxiliary filter element, and an auxiliary filter housing (not shown) for retaining the auxiliary filter element. The final filter assembly 600 will remove the contaminants, such that only contaminant-free air is discharged into the atmosphere. An exemplary operation of the vacuum cleaner will be described with reference to FIGS. 1-9.

The activation of the suction source 180 establishes a suction force at its suction source inlet 181, in the elongated first conduit, and thus in the primary cyclone 321.

The suction force or negative pressure in primary cyclone 321 is communicated to the suction opening 211 formed in the nozzle underside through the hoses and associated fitting members. In combination with the scrubbing action of the rotating brush assembly, the suction force causes dust and dirt from the surface being cleaned to be entrained in the suction airflow and pulled into the primary cyclone 321 through the primary airflow inlet 321a.

The air introduced into the primary cyclone 321 is guided by the guide rib 380 to flow in a direction tangential to the inner peripheral surface of the primary cyclone 321 without being directly introduced into the discharge member 370, thereby forming a spiral flow.

The air acquires a certain swirling force, and the swirling force separates heavy and large dust particles. As a result, relatively heavy and large dust is separated from the air in accordance with the cyclone principle, and is then stored in the primary dust storing part 331 after falling downward.

The dust stored in the primary dust storing part 331 is prevented from floating in accordance with the functions of the floatation prevention member 373 and corrugated boundary wall 335. The air, from which relatively heavy and large dust has been separated, is discharged from the primary cyclone 321 through the primary airflow outlet 321b communicating with the holes 371 formed at the peripheral wall of the discharge member 370.

The finer dust is then filtered through the discharge member 370 placed between the primary cyclone 321 and the secondary cyclones 323. The air is then introduced into the secondary cyclones 323 so that the air is again subjected to a dust separation process in order to separate relatively light and fine dust from the air.

The air, from which relatively light and fine dust has been separated in the secondary cyclones 323, is introduced into the interior of the top cover 310 detachably connected to the dust collecting container 330.

The air introduced into the interior of the top cover 310 is discharged through a cover discharge port 313 formed at the center of the top cover 310. The air emerging from the cover discharge port 313 is introduced into the main filter assembly 500.

The air passes through the apertures formed in the filter housing 510, passes through the main filter element 520 so that residual contaminants are removed, and exits the main filter assembly 500. The air discharging from the main filter assembly 500 is introduced into the suction source 180 through the second conduit 420. The air emerging from the suction source outlet 183 is then introduced into the final filter assembly 600 through the third conduit 430.

In the final filter assembly 600, the air is filtered again by the HEPA filter to remove any contaminants that passed through the dust collector 300 and the main filter assembly 500. The air passed through the final filter assembly 600 is discharged outwardly from the vacuum cleaner to atmosphere.

Implementations of the above-described vacuum cleaner may provide one or more of the following advantages. For example, the simple coupling structure may be relatively convenient to use since the cleaner body is coupled to the nozzle section by a simple hinge assembly.

Dust and dirt are prevented from rising due to the spiral airflow by the floatation prevention member restricting the spiral movement of the dirt and dust. The vacuum cleaner may also separate dust and dirt from the airflow and deposit the dust and dirt easily and conveniently into the dust collecting container.

Other implementations are within the scope of the following claims.

What is claimed is:

1. A vacuum cleaner comprising:
a nozzle section;
a cleaner body coupled to the nozzle section and being in fluid communication with the nozzle section;
a dust collecting container operatively coupled with the cleaner body;
a primary cyclone for separating dust and dirt from a suction airflow flowing into the dust collecting container;
at least one secondary cyclone disposed along a periphery of the primary cyclone for separating dust and dirt entrained in the airflow discharged from the primary cyclone;
a discharge member being centrally arranged in the primary cyclone for filtering the airflow prior to the airflow being discharged from the primary cyclone; and
a floatation prevention member attached to an underside of the discharge member for preventing swirling airflow in the dust collecting container.

2. The vacuum cleaner of claim 1, further comprising a main filter assembly located on an upper part of the at least one secondary cyclone for filtering dust and dirt from the airflow discharged from the at least one secondary cyclone.

3. The vacuum cleaner of claim 1, wherein the discharge member includes a plurality of holes formed along a periphery of the discharge member, the discharge member being mounted on the upper end of the primary cyclone.

4. The vacuum cleaner of claim 3, wherein an inner diameter of the discharge member reduces gradually along a central axis of the discharge member.

5. The vacuum cleaner of claim 1, wherein the floatation prevention member includes an inclined portion and at least one cross blade attached to an underside of the inclined portion.

6. The vacuum cleaner of claim 1, further comprising a suction source having a suction source inlet adjacent to a secondary airflow outlet of the at least one secondary cyclone.

7. The vacuum cleaner of claim 1, wherein a periphery of the at least one secondary cyclone is partially defined by the dust collecting container.

8. The vacuum cleaner of claim 1, wherein a primary airflow inlet of the primary cyclone is tangentially oriented in relation to an axial centerline of the primary cyclone and a primary airflow outlet of the primary cyclone is located in a center of an upper surface of the primary cyclone.

9. The vacuum cleaner of claim 6, wherein a secondary airflow inlet of the at least one secondary cyclone is located in an upper periphery of the at least one secondary cyclone and the secondary airflow outlet of the at least one secondary cyclone is located along a longitudinal axis of the at least one secondary cyclone.

10. The vacuum cleaner of claim 1, the dust collecting container comprising:
a primary dust storing part for storing dust and dirt separated in the primary cyclone and;
a secondary dust storing part for storing dust and dirt separated in the at least one secondary cyclone.

11. A vacuum cleaner comprising:
a nozzle section;
a cleaner body coupled to the nozzle section and in fluid communication with the nozzle section;
a dust collecting container operatively coupled with the cleaner body;
a primary cyclone for separating dust and dirt from a suction airflow flowing into the dust collecting container;
at least one secondary cyclone for separating dust and dirt entrained in the airflow discharged from the primary cyclone;
a main filter assembly located on an upper part of the at least one secondary cyclone for filtering dust and dirt from the airflow discharged from the at least one secondary cyclone; and
a bottom panel coupled to the dust collecting container for covering the dust collecting container.

12. The vacuum cleaner of claim 11, wherein the primary cyclone is located in the dust collecting container and a periphery of the at least one secondary cyclone is at least partially defined by the dust collecting container.

13. The vacuum cleaner of claim 11, further comprising an auxiliary filter assembly disposed downstream from the main filter assembly.

14. The vacuum cleaner of claim 11, wherein the main filter assembly comprises a main filter element and a filter supporter for supporting and installing the main filter element.

15. An upright vacuum cleaner comprising:
a nozzle section;
an upright cleaner body pivotally mounted to the nozzle section and in fluid communication with the nozzle section;
a rotation shaft provided at the upright cleaner body for pivotally mounting the upright cleaner body to the nozzle section;
a body release lever for selectively controlling an inclined operative position of the upright vacuum cleaner;
an agitator motor mounted in the nozzle section for driving an agitator;
a suction source mounted in the upright cleaner body for generating a suction force in the upright cleaner body;
a dust collecting container selectively mounted in at least one of the upright cleaner body and the nozzle section;
a primary cyclone for separating dust and dirt from a suction airflow flowing into the dust collecting container;
at least one secondary cyclone for separating dust and dirt entrained in the airflow discharged from the primary cyclone; and
a main filter assembly located on an upper part of the at least one secondary cyclone for filtering dust and dirt from the airflow discharged from the at least one secondary cyclone.

16. The upright vacuum cleaner of claim 15, wherein the at least one secondary cyclone is disposed along a periphery of the primary cyclone.

17. The upright vacuum cleaner of claim 16, wherein the at least one secondary cyclone and the primary cyclone are formed as a single piece.

18. The upright vacuum cleaner of claim 16, wherein a primary airflow inlet of the primary cyclone is tangentially oriented in relation to an axial centerline of the primary cyclone.

19. The upright vacuum cleaner of claim 16, the dust collecting container comprising:
a primary dust storing part for storing dust and dirt separated in the primary cyclone and;
a secondary dust storing part for storing dust and dirt separated in the at least one secondary cyclone.

20. The upright vacuum cleaner of claim 16, further comprising a top cover detachably connected to the dust collecting container and positioned at an upper end of the dust collecting container.

21. The upright vacuum cleaner of claim 16, further comprising a conduit extending from the at least one secondary cyclone to the suction source.

22. The upright vacuum cleaner of claim 15, further comprising:
a primary airflow inlet of the primary cyclone tangentially oriented in relation to an axial centerline of the primary cyclone; and
a primary airflow outlet of the primary cyclone located in a center of an upper surface of the primary cyclone.

23. The vacuum cleaner of claim 22, further comprising secondary airflow inlets for each of the secondary cyclones, the secondary airflow inlets being positioned above a position of the primary airflow outlet of the primary cyclone.
